(19) United States
(12) Patent Application Publication
(10) Pub. No.: US 2006/0245886 A1
(43) Pub. Date: Nov. 2, 2006

(54) Lift gate hinging mechanism

(75) Inventor: Wayne Krause, Uniontown, OH (US)

Correspondence Address: John M. Skeriotis;Brouse McDowell, LPA, Ste. 500, 388 S. Main Street, Akron, OH, 44311-4407, US

(73) Assignee: Waltco Truck Equipment Company

(21) Appl. No.: 11/077,250

(22) Filed: Mar. 10, 2005

(51) Int. Cl. B60P 1/00

(52) U.S. Cl. 414/558

(57) ABSTRACT

A lift gate includes a one or more lift gate platforms that are connected together via hinges. A plurality of torsion bars are connected between the platforms and the hinges to provide assistance to the operator when opening or closing the lift gate platforms. More specifically, the lift gate includes two separate torsion bars connected between a bracket and a hinge mechanism respective to the one or more lift gate platforms.

### BACKGROUND OF THE INVENTION

1. Field of Invention

This invention pertains to the art of methods and apparatuses for vehicle cargo decks, and more specifically to a folding deck system.

2. Brief History

It is well known in the art to provide a lift gate on the rear of a vehicle and more specifically, on the rear of truck capable of carrying a designated cargo. The lift gate may be manually or mechanically operated to move from a closed position, when not in use, to an open position when in use. The lift gate may additionally be raised or lowered with respect to the cargo floor so that the payload can be maneuvered from the cargo area to the surface of the lift gate and subsequently to the ground.

As the lift gate may be open and closed, one configuration of lift gate may include one or more sections that fold to reduce the cross sectional area of the lift gate when the lift gate is not in use. The lift gate section may be coupled using hinges and may further include a torsion bar to help overcome the weight of the lift gate during opening or closing. However, using a torsion bar may cause one lift gate section to be offset with respect the other lift gate section thereby creating an uneven surface. This is caused by the potential energy stored in the torsion bar when the liftgate is opened. This is undesirable when loading or unloading cargo from the vehicle because the uneven surface inhibits the operator from moving the cargo onto and off of the surface of the lift gate.

The subject invention obviates the aforementioned problems by incorporating a mechanism that does not cause the lift gate platforms to be uneven when opened but still provides the added assistance, via a torsion bar assembly, to help close the lift gate.

### SUMMARY OF THE INVENTION

One advantage of this invention includes a folding vehicle deck that comprises a first deck platform having first and second edges; at least a second deck platform having first and second edges; first and second platform hinging portions operatively rotatably hinging the second deck platform with respect to the first deck platform; a first spring means having first and second ends, wherein the first end of the first spring means is operatively fixedly received by the first deck platform, wherein the second end of the first spring means is operatively fixedly received by the first platform hinging portion; and, a second spring means having first and second ends, wherein the first end of the second spring means is operatively fixedly received by the second deck platform, wherein the second end of the second spring means is operatively by the second platform hinging portion.

Another advantage of this invention includes a folding vehicle deck, wherein the first spring means is a first torsion bar.

Another advantage of this invention includes a folding vehicle deck, wherein the second spring means is a second torsion bar.

Another advantage of this invention includes a folding vehicle deck, wherein the first and second platform hinging portions include first and second distinct hinging members respectively, wherein the first and second platform hinging members are operatively connected are distal edges of the first deck platform and the second deck platform.

Another advantage of this invention includes a folding vehicle deck, further comprising: connecting means for use in operatively connecting the first deck platform to an associated vehicle.

Another advantage of this invention includes a folding vehicle deck, further comprising: a first bracket fixedly connected with respect to the first deck platform; at least a second bracket fixedly connected with respect to the at least a second deck platform; wherein the first end of the first torsion bar is operatively received by the first bracket, wherein the second end of the first torsion bar is operatively received by the first platform hinging portion; and, wherein the first end of the second torsion bar is operatively fixedly received by the second bracket, wherein the second end of the second torsion bar is operatively received by the second first platform hinge.

Another advantage of this invention includes a folding vehicle deck, wherein the second deck platform folds between an open position and an closed position with respect to the first deck platform; and, wherein the first torsion bar is preloaded when the at least a second deck platform is closed with respect to the first deck platform.

Another advantage of this invention includes a folding vehicle deck, wherein the first torsion bar has substantially no preload when the at least a second deck platform is open with respect to the first deck platform.

Another advantage of this invention includes a folding vehicle deck, wherein the second torsion bar is preloaded when the at least a second deck platform is closed with respect to the first deck platform.

Another advantage of this invention includes a folding vehicle deck, wherein the second torsion bar has substantially no preload when the at least a second deck platform is open with respect to the first deck platform.

Another advantage of this invention includes a folding vehicle deck, wherein the second torsion bar is preloaded when the at least a second deck platform is open with respect to the first deck platform.

Another advantage of this invention includes a folding vehicle deck, wherein the second torsion bar has substantially no preload when the at least a second deck platform is closed with respect to the first deck platform.

Another advantage of this invention includes a folding vehicle deck, wherein the first torsion bar is substantially longer than the second torsion bar.

Another advantage of this invention includes a folding vehicle deck, wherein the first torsion bar has a characteristic length R1, and, wherein the second torsion has a characteristic length R2, and, wherein the ratio of R1 to R2 is between 1 and 3.

Still other benefits and advantages of the invention will become apparent to those skilled in the art to which it pertains upon a reading and understanding of the following detailed specification.

### BRIEF DESCRIPTION OF THE DRAWINGS

The invention may take physical form in certain parts and arrangement of parts, a preferred embodiment of which will be described in detail in this specification and illustrated in the accompanying drawings which form a part hereof and wherein:

FIG. 1 is a perspective view of a vehicle with attached lift gate.

FIG. 2 is an exploded view of the lift gate.

FIG. 3 is a cross-sectional view of lift gate with torsion bar.

FIG. 4 is a perspective view of a lift gate hinge.

### DESCRIPTION OF THE PREFERRED EMBODIMENT

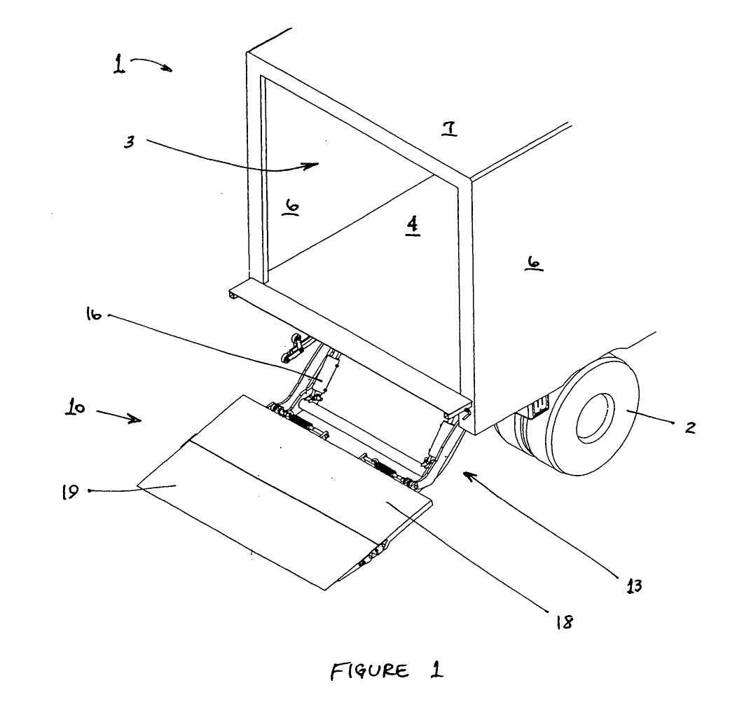

Referring now to the drawings wherein the showings are for purposes of illustrating a preferred embodiment of the invention only and not for purposes of limiting the same, FIG. 1 shows a vehicle 1, which may be truck 1. As is well known in the art, the vehicle 1 may include a vehicle frame, an engine, a transmission (all not shown) and wheels 2. The vehicle I or truck 1 may also include a cargo area 3 for use in carrying a designated cargo or payload. Part or all of the cargo area 3 may include a vehicle bed 4 on which the cargo may be placed for transporting between desired locations. In one embodiment, the vehicle 1 may include side walls 6 and a roof 7 for enclosing the cargo thereby shielding the cargo from the elements during transportation. It is noted that the vehicle 1 may include a suspension appropriately sized for carrying a maximum payload. In that the suspension and construction of a payload carrying vehicle is well known in the art, no further explanation will be offered at this time. The subject invention is not to be limited to a specific vehicle or a vehicle capable of supporting a certain payload capacity. The subject invention may be utilized on any type of vehicle as chosen with sound engineering judgment.

With reference to FIG. 1, the vehicle 1 may include lift gate, shown generally at 10. The lift gate 10 may be connected to the frame, not shown, of the vehicle 1 in any manner chosen with sound engineering judgment. In one embodiment, the lift gate 10 may include a lift gate frame assembly 13. The frame assembly 13 may be moveably connected with respect to the frame, not shown, of the vehicle 1 in any manner chosen with sound engineering judgment, including but not limited to: pivotally, rotatably, linearly, laterally and the like. Moreover, any configuration of frame assembly 13 may be chosen with sound engineering judgment. In this manner, an actuator 16, or actuators 16, may be included to provide locomotive power to selectively move the frame assembly 13 and corresponding lift gate 10 as desired, as will be discussed in detail in a subsequent paragraph. Correspondingly, a lift gate controller, not shown, may also be included to allow an operator to selectively control the position of the lift gate 10.

With continued reference to FIG. 1, the actuators 16 may be implemented to move the lift gate 10 between maximum and minimum positions. In one such lift gate position, the lift gate may be positioned fully up. By fully up it is meant that the cargo carrying surface of the lift gate 10 is substantially in-line with the cargo bed 4. This allows the associated cargo to be moved directly onto or off of the cargo bed area. In another position, the lift gate 10 may be positioned fully down or proximate to the ground for loading onto or unloading off of the lift gate 10. It is noted that the lift gate 10 may be infinitely positioned at any location between fully up or fully down. Any manner of movement and/or positioning of the lift gate 10 may be chosen with sound engineering judgment. In one embodiment, the actuators 16 may be hydraulic actuators 16 or hydraulic cylinders 16. However, any manner of providing locomotion to the lift gate 1 may be chosen with sound engineering judgment. In this manner, cargo may be conveniently loaded onto and off of the vehicle 1 as desired.

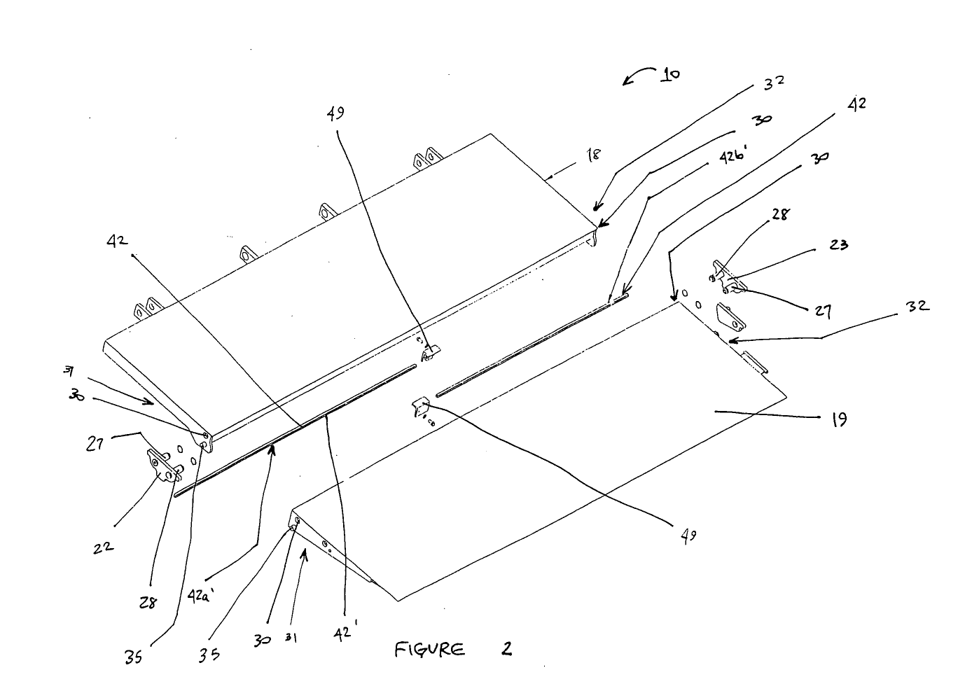

With continued reference to FIG. 1 and now to FIG. 2, the lift gate 10 may include lift gate platforms. In one embodiment, the subject invention may include two lift gate platforms 18, 19. However, any number of platforms may be incorporated into the invention as chosen with sound engineering judgment. The lift gate platforms 18, 19 may be juxtaposed to span a given surface area, as shown in FIG. 1. The first platform 18 may be rotatably connected with respect to the second platform 19. More specifically, in one embodiment, the first platform 18 may be hinged with respect to the second platform 19, which will be discussed further in a subsequent paragraph. Additionally, the first platform 18 may be rotatably connected with respect to the frame assembly 13. It is to be construed that any manner of connecting the platforms and frame assembly together may be chosen with sound engineering judgment. In this manner, the lift gate 10 may be swung out of the way when it is not being utilized, such as during actual transportation of the cargo. It is noted that the storage position of the lift gate 10 may be any position chosen with sound engineering judgment.

With continued reference to FIG. 2, the first and second platforms 18, 19 may be hingingly connected together by means of hinges 22, 23. In this embodiment, one hinge portion 22 may be rotatably connected between the first and second platforms 18, 19 at one edge 31. Similarly, a second hinging portion 23 may rotatably connect the platforms 18, 19 at the distal edge 32 of the platforms respectively. It is noted that other configurations of hinging mechanisms may be contemplated. Therefore the subject invention is not to be limited by the specific configuration of hinges but may also have incorporated, for example, a single contiguously formed hinge with separate hinging portions. Any manner of hinging or rotatably connecting the platforms together may be chosen with sound engineering judgment. Additionally, the hinging portions and/or members may be hinged to the platforms 18, 19 at any location on the platforms 18, 19 as chosen with sound engineering judgment.

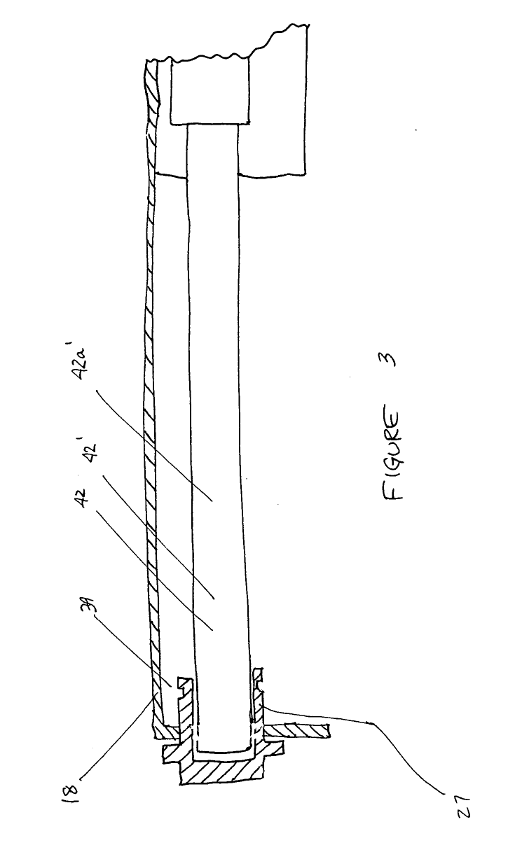

With continued reference to FIG. 2 and now to FIG. 3, the hinges 22, 23 may include extending platform pivot hubs 27, 28. The pivot hubs 27, 28 may be fit into holes 30 fashioned in the first 32 and second 33 ends of the platforms 18, 19 respectively. In this manner, the platforms 18, 19 may be rotatably, hingingly connected together. Fasteners, snap rings, or any other mechanism may be incorporated to hold the hinges 22, 23 in place during use as chosen with sound engineering judgment. This allows the second platform 19 to pivot upward with respect to the first platform 18, as in the case when the deck 10 is being placed in a stored or unused position. Platforms pins 35 may be used to prevent the second platform 19 from rotating downward with respect to the first platform 18. However, any means of restricting platform movement can be chosen with sound engineering judgment. It is also contemplated in an alternate embodiment that the second platform 19 may rotate downward with respect to the first platform 18. Still, any direction of rotation of the platforms 18, 19 may be chosen with sound engineering judgment.

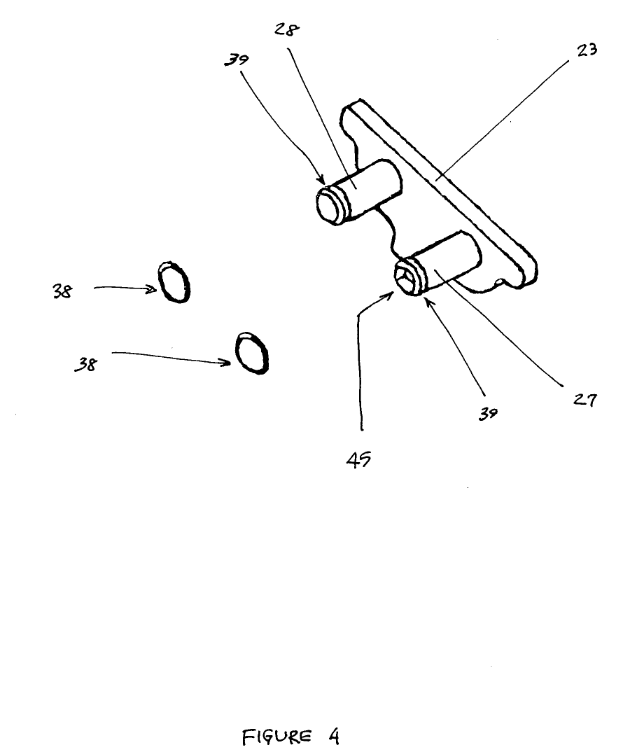

With reference to FIG. 4, hinge 23 is shown and will be discussed as an example of how the hinge mechanisms function with the subject invention. It is to be construed that the features of hinge 23 can similarly be applied to the opposing reverse-image hinge 22. As discussed above, the hinge mechanism includes pivot hubs 27, 28. The pivot hubs 27, 28 may fit within holes 30 fashioned in the lift gate platforms 18, 19. Snap rings 38 may be placed on grooves 39 on the pivot hubs 27, 28 to hold the hinges 22, 23 in place after they have been inserted through the holes 30 in the platforms 18, 19. One of the pivot hubs 27 may include hollow center 45 fashioned to receive a spring means 42, which may be a torsion bar 42′ to be discussed in detail in a subsequent paragraph. In one embodiment, the cross section of the spring means 42 is square. The center 45 of the pivot hub 27 may also be square so as to receive the spring means 42 at one end. It is noted that any configuration of center 45 and cross section of spring means 42 may be chosen with sound engineering judgment. The end of the spring means 42 is thus prevented from rotating with respect to the hinge 22, 23. In this manner, rotating the hinge 22, 23 will cause that end of spring means 42 to rotate as well. It is noted that pivot hub 27 on hinge 23 corresponds to platform 19 and pivot hub 27 on hinge 22 corresponds to platform 18.

With reference again to FIG. 2, brackets 49 may be fixedly attached to the platforms 18, 19 respectively. In one embodiment, a right handed bracket 49 may be attached to platform 18 and in a similar manner a left handed bracket 49 may be attached to platform 19. It is to be noted that the right handed and left handed correspond to the hinges 22, 23 respectively. The brackets 49 may include a hollow center similar to the pivot hubs 27 for use in receiving spring means 42 at an opposing end. In that the brackets 49 are fixedly connected with respect to one of the platforms 18 or 19, the end of the spring means 42 received within bracket 49 is also fixed in place respective to platform 18 or 19.

With reference now to FIGS. 2 through 4, in one embodiment spring means 42 may be a generally longitudinal torsion bar 42′. The torsion bar 42′ may have a generally square cross section for use in fitting within a hinge at one end and a bracket 49 at the distal end. In this manner, the ends of the torsion bar 42′ are constrained to move in conjunction with the hinge and bracket respectively. In other words, if the hinge 23 pivots, the end of the torsion bar 42′ connected to the hinge 23 also pivots. Similarly, if the bracket 49, and corresponding platform, remains stationary, the end of the torsion bar 42′ connected to the bracket 49 remains stationary. In this manner, the torsion bar 42′ then undergoes torsion when the hinge pivots respective to the bracket and platform. The torsion bar 42′ thus resists the torque and stores potential energy. It is noted that the torsion bar 42′ stores energy when the operator lifts the second platform 19 with respect to the first platform 18. Continuing, the lift gate 10 may include first and second torsion bars 42a′, 42b′. The first torsion bar 42a′ may correspond to the first platform 18 by engaging hinge 22. Similarly, the second torsion bar 42b′ may correspond to the second platform 19 by engaging hinge 23.

With continued reference to all of the FIGURES, the first and second torsion bars 42a′ and 42b′ may have substantially the same length R. However, it is contemplated in an embodiment, that the first torsion bar 42a′ may have a length R1 and torsion bar 42b′ may a length R2 where R1 and R2 are substantially different in length. The ratio of R1 to R2 may fall within the range of between 1 and 3. In this manner, the position of the brackets 49 may be positioned laterally along the platforms 18, 19 respectively so as to engage the torsions bars 42′ as described above. Any position of the brackets 49, with respect to the platforms 18, 19, may be chosen with sound engineering judgment.

With reference to all of the FIGURES, the torsion bars 42′ may be configured such that there is no torque on the torsion bars 42′ when the lift gate is open. That is to say that when the first and second lift gate platforms 18, 19 are substantially coplanar, the hinge 22, 23 and brackets 49 are aligned such that the torsion bars 42′ are not twisted. In this manner, when the lift gate is folded up or closed, the torsion bars 42′ may be torqued thereby storing potential energy. This assists the operator when opening the lift gate. It is contemplated in an alternate embodiment that the torsion bars 42′ may be torqued when the lift gate is in the opened position thereby assisting the operator when closing the lift gate. Any manner of configuring the hinges, brackets, platforms and torsion bars may be chosen with sound engineering judgment.

The preferred embodiments have been described, hereinabove. It will be apparent to those skilled in the art that the above methods may incorporate changes and modifications without departing from the general scope of this invention. It is intended to include all such modifications and alterations in so far as they come within the scope of the appended claims or the equivalents thereof.

I/We claim:

1. A folding vehicle deck, comprising:
a first deck platform having first and second edges;
at least a second deck platform having first and second edges;
first and second platform hinging portions operatively rotatably hinging the at least a second deck platform with respect to the first deck platform;
a first spring means having first and second ends, wherein the first end of the first spring means is operatively fixedly received by the first deck platform, wherein the second end of the first spring means is operatively fixedly received by the first platform hinging portion; and,
a second spring means having first and second ends, wherein the first end of the second spring means is operatively fixedly received by the at least a second deck platform, wherein the second end of the second spring means is operatively by the second platform hinging portion.

2. The deck of claim 1, wherein the first spring means is a first torsion bar.

3. The deck of claim 2, wherein the second spring means is a second torsion bar.

4. The deck of claim 1, wherein the first and second platform hinging portions include first and second distinct hinging members respectively, wherein the first and second platform hinging members are operatively connected are distal edges of the first deck platform and the at least a second deck platform.

5. The deck of claim 4, further comprising:
connecting means for use in operatively connecting the first deck platform to an associated vehicle.

6. The deck of claim 3, further comprising:
a first bracket fixedly connected with respect to the first deck platform;
at least a second bracket fixedly connected with respect to the at least a second deck platform;
wherein the first end of the first torsion bar is operatively received by the first bracket, wherein the second end of the first torsion bar is operatively received by the first platform hinging portion; and,
wherein the first end of the second torsion bar is operatively fixedly received by the at least a second bracket, wherein the second end of the second torsion bar is operatively received by the at least a second first platform hinge.

7. The deck of claim 6, wherein the at least a second deck platform folds between an open position and an closed position with respect to the first deck platform; and,
wherein the first torsion bar is preloaded when the at least a second deck platform is closed with respect to the first deck platform.

8. The deck of claim 7, wherein the first torsion bar has substantially no preload when the at least a second deck platform is open with respect to the first deck platform.

9. The deck of claim 8, wherein the at least a second torsion bar is preloaded when the at least a second deck platform is closed with respect to the first deck platform.

10. The deck of claim 9, wherein the at least a second torsion bar has substantially no preload when the at least a second deck platform is open with respect to the first deck platform.

11. The deck of claim 8, wherein the at least a second torsion bar is preloaded when the at least a second deck platform is open with respect to the first deck platform.

12. The deck of claim 9, wherein the at least a second torsion bar has substantially no preload when the at least a second deck platform is closed with respect to the first deck platform.

13. The deck of claim 3, wherein the first torsion bar is substantially longer than the second torsion bar.

14. The deck of claim 3, wherein the first torsion bar has a characteristic length R1, and,
wherein the second torsion has a characteristic length R2, and,
wherein the ratio of R1 to R2 is between 1 and 3.
